(19) United States
(12) Patent Application Publication
(10) Pub. No.: US 2014/0147066 A1
(43) Pub. Date: May 29, 2014

(54) BEARING ARRANGEMENT FOR A SHAFT OF A TURBINE WHEEL

(71) Applicants: Bernhard Schweizer, Kassel (DE); Mario Sievert, Rotgesbuttel (DE)

(72) Inventors: Bernhard Schweizer, Kassel (DE); Mario Sievert, Rotgesbuttel (DE)

(73) Assignee: VOITH PATENT GMBH, Heidenheim (DE)

(21) Appl. No.: 13/884,884

(22) PCT Filed: Nov. 11, 2011
(86) PCT No.: PCT/EP11/05674

§ 371 Date: Sep. 17, 2013

(30) Foreign Application Priority Data
Dec. 1, 2010 (DE) 10 2010 052 892.7

(51) Int. Cl. F16C 17/18; F16C 32/06

(52) U.S. Cl. CPC F16C 17/18; F16C 32/0633
USPC 384/114

(57) ABSTRACT

The invention relates to a bearing arrangement for a shaft (3) of a turbine wheel (2) or of a turbine wheel (2) and of a compressor wheel (4), wherein—the turbine wheel (2) is driven by the exhaust gas of a vehicle drive unit, said bearing arrangement comprising—a static housing (9), which—together with a bearing bushing (10) arranged in a rotationally movable manner relative to the housing (9)—encloses a first bearing gap (11), wherein—the bearing bushing (10) accommodates the shaft (3) in a rotationally movable manner and encloses a second bearing gap (12) together with the shaft. The invention is characterized in that a ratio (R1/R2) of radii (R1, R2) of the first bearing gap (11) and of the second bearing gap (12) with respect to a rotational axis (14) of the shaft (3) changes at least once over the maximum axial extent (x) of the bearing bushing (10).

The invention relates to a bearing arrangement for a shaft of a turbine wheel or a turbine wheel and a compressor wheel according to a type defined in detail in the preamble of claim 1.

Turbochargers in the same way as turbocompound systems are known from the general prior art. Both are used in combination with vehicle drive units, typically internal combustion engines, and are used to convert thermal energy and pressure energy which is present in the exhaust gases of the drive unit into mechanical energy via a turbine wheel. In a turbocharger or exhaust gas turbocharger this mechanical energy is typically converted directly via a shaft connecting the turbine wheel to a compressor wheel into rotational energy for the drive of the compressor wheel. Air for the drive unit, in particular intake air for the internal combustion engine is thereby compressed via the compressor wheel and can thus be supplied at an elevated charging pressure. In particular in an internal combustion engine this increase in the charging pressure and associated increase in the air mass supplied to the internal combustion engine brings about a more efficient combustion and a better utilization of the energy stored in the fuel.

In the turbocompound system it is the case that the energy recovered from the hot exhaust gases via the turbine wheel as impeller is likewise converted into mechanical rotational energy at a shaft carrying the turbine wheel. This energy is then, however, used for the mechanical drive of components and for feedback of mechanical energy, for example, in the region of the crankshaft of an internal combustion engine.

Both in the turbocharger with turbine wheel and compressor wheel and also in the turbocompound system, fluid dynamic bearings are usually used for journalling the shaft which, according to the general prior art, comprise circular cylindrical bearing bushings. These are typically designed as floating bushings so that the bearing bushing has two bearing gaps, one between a static fixed housing and the bearing bushing on the one hand between the shaft and the bearing bushing on the other hand. The floating arrangement of the bearing bushings allows rotation of the same between the shaft and the housing during operation. This is primarily caused by the fact that as a result of the small radial gap dimensions of the bearing gap, the viscous resistance or retarding forces result in an angular momentum on the floating bearing bushing so that this is set in rotation.

Such bearings are in this case typically supplied with oil through lubricating oil holes in the area of the bearing bushing so that both bearing gaps have a corresponding oil film. In order to form a hydrodynamic lubricating film which minimizes the friction and the wear in particular between the shaft and the bearing bushing, corresponding rotational speeds of the bearing bushing itself are required and desired. At such high rotational speeds of the floating bearing bushing however, there is then the risk that self-excited vibrations are formed which are caused by eddies in the lubricating film. Whereas the hydrodynamic lubricating film in the bearing gaps normally ensures a desired damping of the rotating shaft, under such operating states, a reduced damping and stiffness of the shaft movement comes about, which ultimately can lead to an undesired wear. In addition, during operation of the bearing with the floating bearing bushing, subharmonic excitations occur which cause acoustic noise. This should be prevented on the one hand as a result of the undesired noise emissions and can on the other hand result in such large amplitudes of the subharmonic excitation that the bearing thus becomes unstable. At worst this results in damage to the turbine wheel due to an impact against the housing.

As an example, reference should be made to DE 10 2004 009 412 A1 with regard to the bearing of the shaft of an exhaust turbocharger. Such a bearing is also known from DE 195 39 678 A1. A floating bearing bushing is described within the framework of DE 195 39 678 A1, which guides a lubricating oil flow from one bearing gap to the other bearing gap via suitable openings. The particular feature according to the invention now lies in the fact that the configuration of these conveying openings for the lubricating oil is configured so that these counteract an increasing rotation of the floating bearing bushing with increasing rotational speed of the shaft.

In addition, bearings in the form of fluid dynamic bearings are known from the further general prior art, for example, in the form of DE 1 575 563, in which the bearing bushing or the shaft mounted in the bearing bushing have cross-sectional profiles which differ from one another in a cross-section perpendicular to the rotational axis. These non-round or at least non-circular cross-sectional profiles enable and improve the configuration of a hydrodynamic lubricating film. In the case of floating bearing bushings however, such a configuration is only possible to a limited extent since these typically tend to promote the entrainment of the bearing bushing to a high rotational speed with correspondingly high shaft rotational speed rather than counteract this.

Against this background, it is now the object of the present invention here to provide a bearing arrangement for a shaft of a turbine wheel or a turbine wheel and a compressor wheel which is designed so that undesired vibrations are avoided and at the same time the expenditure during manufacture in reduced.

This object is solved by a bearing arrangement having the features of the characterizing part of claim 1. The features in the characterizing part of claims 3 and 6 provide alternative independent solutions for the above-mentioned object. The subclaims which depend on this in each case describe particularly favourable and advantageous further embodiment of the particular bearing arrangements according to the invention.

The first solution of the aforesaid object is achieved according to the characterizing part of claim 1 whereby a ratio of radii of the first bearing gap and of the second bearing gap with respect to a rotational axis of the shaft changes at least once over the maximum axial extent of the bearing bushing. The two bearing gaps can therefore, for example, run obliquely towards one another so that the floating bearing bushing is configured to be substantially conical. Alternative embodiments, for example with a bearing gap which runs in several steps going over into one another continuously or abruptly in axial direction would also be feasible. Ultimately, it would also be feasible to configure the bearing gaps so that these either have different axial lengths or are disposed at different positions in the axial direction. This also results in changes or jumps in the ratio of their radii over the axial extent of the floating bearing bushing.

An alternative to this is described by the features in the characterizing part of claim 3. According to this embodiment of the bearing according to the invention, the bearing gaps are disposed eccentrically with respect to one another. The bearing gaps here can again be configured in the manner of lateral surfaces of circular cylinders. However, the central axes of the respective circular cylinders do not lie congruently on one another but run parallel adjacent to one another or can even run at an angle to one another. Such an eccentric arrangement of the bearing gaps with respect to one another can therefore also solve the aforesaid object.

In a particularly favourable and advantageous manner, by means of the previously described solutions according to the invention it is provided that the bearing gaps have a constant gap width in axial direction. This constant gap width of the bearing gap in axial direction forms a particularly simple and efficient structure regardless of the profile of the bearing gap itself, which can be achieved correspondingly simply in particular in the production. In addition, it allows an efficient and uniform mounting over the entire available bearing surface due to the bearing gap having constant gap width.

Finally, in addition a solution as specified in the characterizing part of claim 6 can also solve the aforesaid object. In this case, it is provided that at least one of the bearing gaps changes in its axial direction with regard to the gap width, that is the radial gap dimension. The structure then has a conical bearing gap.

All three geometrical solution variants in this case are based on the same mechanism. The solution variants can each be used individually and/or in combination with one another. The common effect forming the basis of these embodiments enables the excitation of vibrations to be minimized. The reliability of the mounting is thereby increased and the acoustic emissions are reduced. According to the studies of the inventor, the geometric configurations described above, each alone or in combination with one another, are able to produce forces in the form of a multidimensional vector field during operation which, at the same time, lead to a stabilization of the bearing arrangement, for example, by vector components acting in the direction of the axis of rotation, and also to a reduction of vibrations. In addition, the axial bearings are unloaded by corresponding forces or in certain cases, an axial bearing can even be completely dispensed with. The approach according to the invention can be achieved very simply and cost-effectively since it does not attempt to mitigate the effect of the vibrations which have already occurred but since such undesirable vibrations are already prevented from forming. In particular, in the presence of or in combination with the eccentric arrangement of the bearing gaps, a desired imbalance is additionally formed which counteracts the excitation of vibrations in an appropriate manner.

In a particularly advantageous further embodiment of the structure of the bearing arrangement according to the invention, it is further provided that both bearing gaps are configured to be inclined towards one another. As a result of their inclinations having different algebraic signs, forces occur during operation which always have a vector component in the axial direction. Since the vector components in one bearing gap run in the opposite direction to the other bearing gap depending on the inclination, this results in a lateral stabilization of the bearing arrangement during operation.

In a further very advantageous embodiment of the bearing according to the invention, it is further provided that the material thickness and/or material condition of the bearing bushing differ in the course of the axial extent of the bearing bushing. In addition to the different wall or material thickness of the bearing bushing caused by the desired geometry, the change in shape is also accompanied by a change in the centre of gravity with the consequence of a substantially changed dynamic behaviour. This can be used to ensure a certain vibration behaviour. In the same way, this effect can also be achieved by different materials, for example, materials of different densities. The flow ratios of the lubricating oil in the respective bearing gap can also be influenced by surface structurings or by the use of surface roughnesses.

According to a very advantageous further embodiment of the bearing arrangement according to the invention, it is further provided that the bearing bushing has a static and/or dynamic imbalance with respect to its geometrical central axis. This promotes the pressure build-up in the bearing gap. At the same time, as a result of the embodiments described above, a predetermined difference in rotational speed of the bearing bushing with respect to the shaft can be set which, for example, is used to avoid undesirable acoustic effects. Thus, in practice an advantageous rotational speed of the bearing bushing of 20% to 50% in relation to the rotational speed of the shaft can be set, which has proved to be particularly efficient.

Further advantageous embodiments of the bearing arrangement according to the invention in various possible variants are obtained from the remaining dependent subclaims and become clear by means of exemplary embodiments which are described in detail hereinafter with reference to the figures.

In the figures:

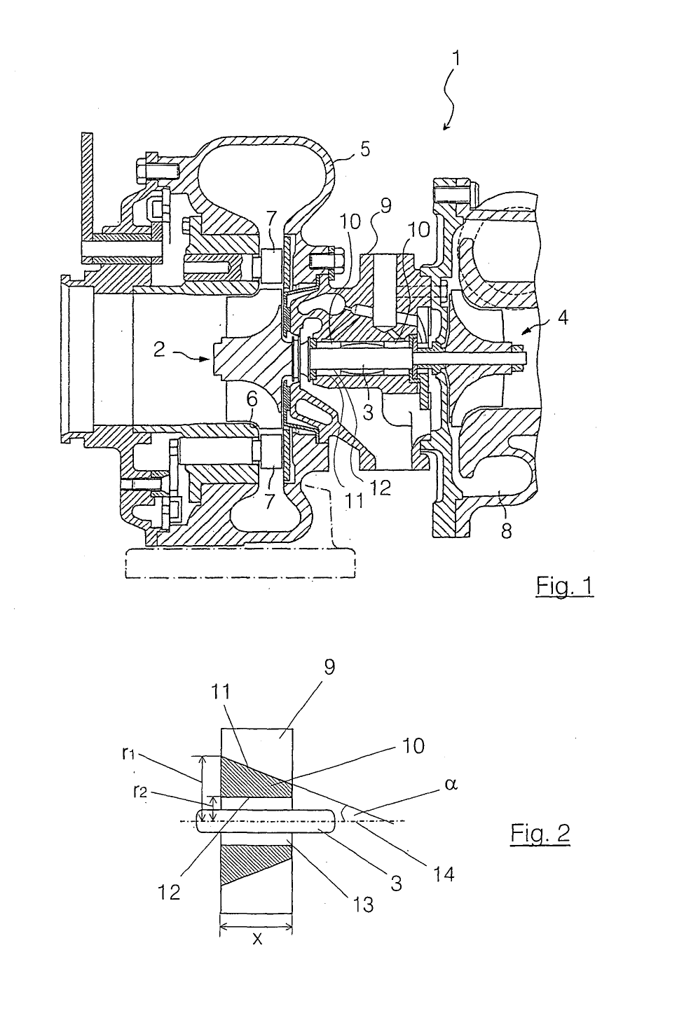

FIG. 1 shows a sectional view of an exemplary turbocharger to illustrate the bearing according to the invention;

FIG. 2 shows a bearing arrangement with a bearing bushing having an inclined bearing gap;

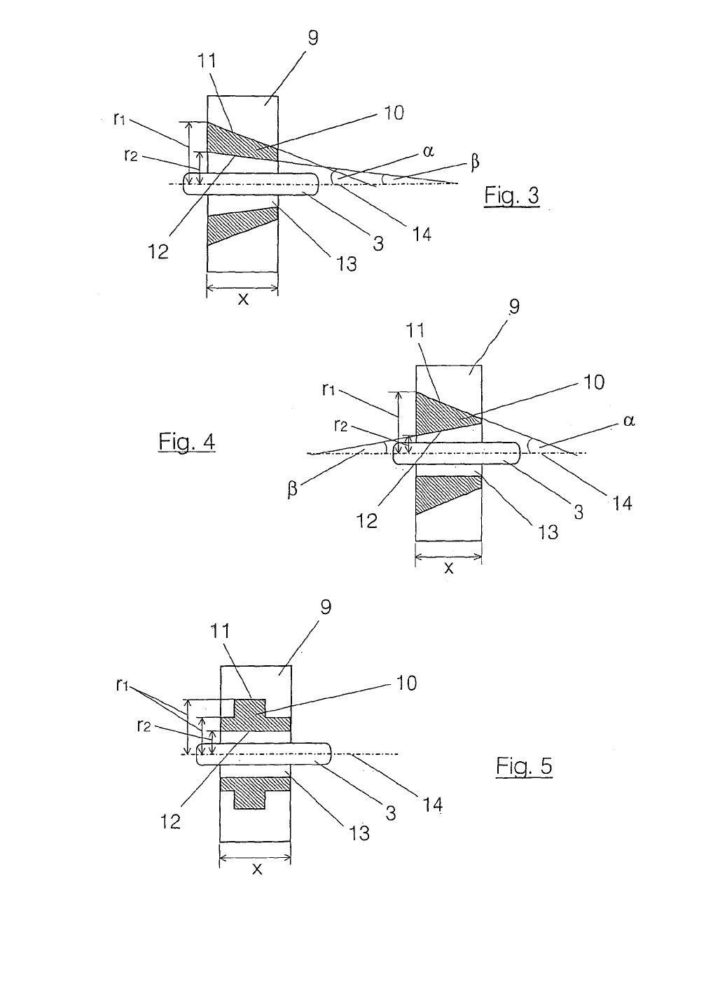

FIG. 3 shows a bearing arrangement with a bearing bushing having two bearing gaps which are inclined with respect to one another;

FIG. 4 shows a bearing arrangement with two bearing gaps which are inclined in opposite directions;

FIG. 5 shows a bearing bushing having two cylindrical regions having different diameters;

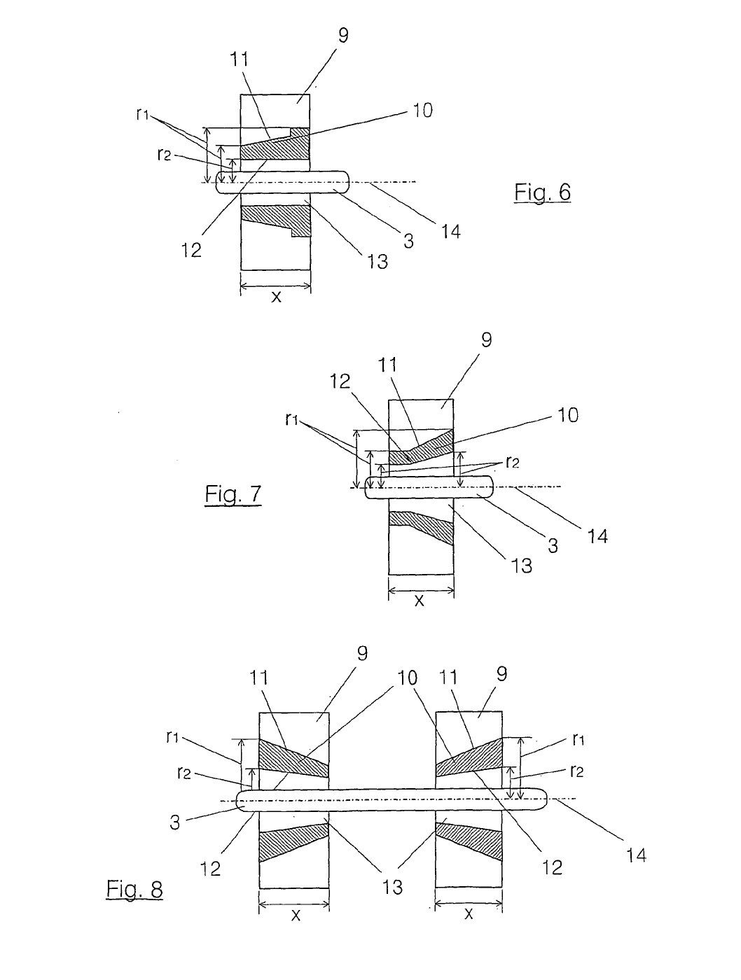

FIG. 6 shows a bearing bushing whose outer bearing gap has a cylindrical region and a conical region;

FIG. 7 shows a bearing bushing whose outer and inner bearing gap each have a cylindrical region and a conical region;

FIG. 8 shows a bearing arrangement with two bearing bushings according to FIG. 3;

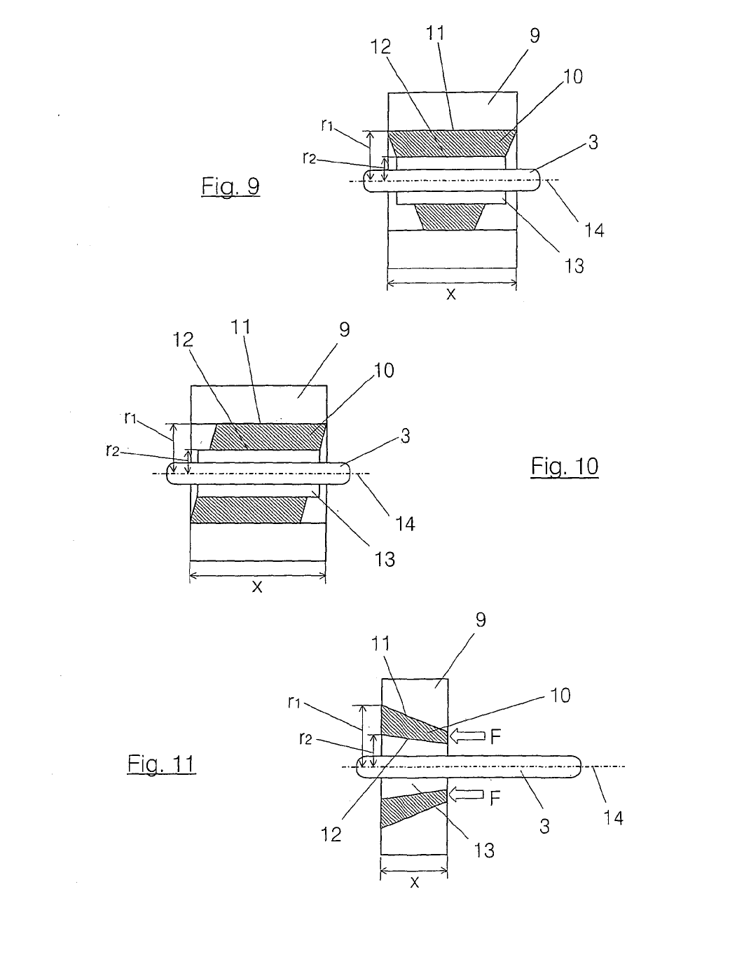

FIG. 9 shows a bearing bushing having two concentric bearing gaps of different length;

FIG. 10 shows a bearing bushing having two concentric bearing gaps of the same length with an axial offset;

FIG. 11 shows a bearing bushing which is axially displaceable against the force of a spring element;

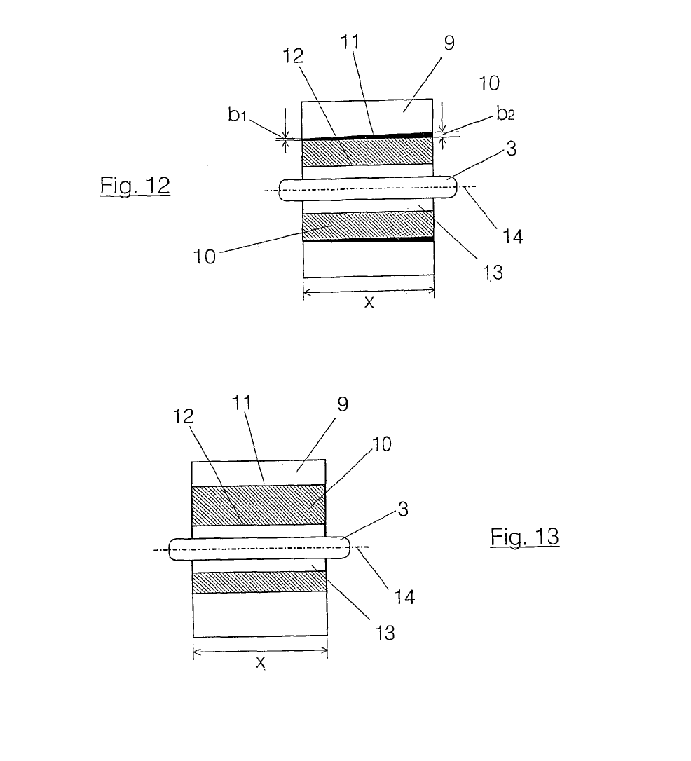

FIG. 12 shows a bearing bushing having a variable bearing gap in the axial direction; and

FIG. 13 shows a bearing bushing having two cylindrical gaps in an eccentric arrangement.

An exhaust gas turbocharger 1 can be identified in the diagram of FIG. 1, for which the invention will be explained as an example. This can naturally also be applied similarly to a shaft and a turbine wheel of a turbocompound system. The exhaust gas turbocharger 1 comprises a turbine wheel 2, a shaft 3 and a compressor wheel 4. Exhaust gas, for example, hot exhaust gas from the region of an internal combustion engine not shown flows into the region of the turbine wheel 2 via a spiral housing 5 running in a spiral shape around the outer circumference of the turbine wheel 2 and drives this turbine wheel as a result of its blading 6. In the exemplary embodiment shown here, a variable turbine guide baffle with guide vanes 7 can be identified between the spiral housing 5 and the blades 6 of the turbine wheel 2. This is known from the general prior art and is frequently common in turbochargers 1. It has no influence whatsoever on the present invention here so that its functionality is not discussed in detail. The exhaust gas turbocharger 1 could also be implemented without the guide vanes 7.

The shaft 3 is connected in a torque-proof manner to the turbine wheel 2 which for its part is connected in a torque-proof manner to the compressor wheel 4. The compressor wheel 4 sucks in fresh air from the surroundings and compresses this in the region of a spiral housing 8, which is disposed around the compressor wheel 4. The compressed air is then used to increase the air mass for the internal combustion engine, for so-called supercharging. The turbocharger 1 additionally has a static housing 9 which is situated between the turbine wheel 2 and the compressor wheel 4. In the region of this static housing 9 the shaft 3 is mounted by means of bearing bushings 10. Lubricating oil is supplied to the bearing bushings 10 via the housing 9 via lines shown in principle so that a fluid dynamic bearing is formed. The bearing bushings 10 which will be discussed in further detail subsequently, are configured as floating bearing bushings 10. This means that they form a first bearing gap 11 between the housing 9 and the bearing bushing 10, as well as a second bearing gap 12 between the bearing bushing 10 and the shaft 3. This can be better identified in the enlarged schematic view of one of the bearing bushings 10 in the diagram in FIG. 2.

The schematic diagram in FIG. 2 shows the shaft 3 as well as the static housing 9 and a ring 13 disposed in a torque-proof manner on the shaft or formed in one piece with the shaft 3. This ring or bearing ring 13 is shown comparably in FIG. 2 and in each of the following figures and should in particular be formed in one piece with the shaft. The second bearing gap 12 already mentioned above now lies between this bearing ring 13 and the bearing bushing 10 whereas the first bearing gap 11 is located between the bearing bushing 10 and the housing 9. The bearing gaps 11, 12 can be supplied with lubricating oil in a manner known per se. For this purpose, in addition to a hole in the housing 9, one or more holes can be provided in the region of the bearing bushing 10 itself. To simplify this and the following representation, a representation of such holes is dispensed with.

The bearing gaps 11, 12 and the floating bearing bushing 10 are such configured to that the first bearing gap 11 has a first radius r₁ with respect to a rotational axis 14 of the shaft 3. The second bearing gap 12 has a radius r₂ which differs from this. The two radii r₁ and r₂ are shown as an example here in an axial position. In the diagram of FIG. 2 the first bearing gap 11 is configured in the manner of a conical envelope surface, therefore runs at an inclination to the rotational axis 14 of the shaft 3. The radius r₁ of the first bearing gap 11 varies over the maximum width of the bearing bushing 10, which is characterized by x in the diagram of FIG. 2. In this exemplary embodiment, the second bearing gap 12 should be configured as the lateral surface of a circular cylinder so that the radius r₂ of the second bearing gap 12 does not vary over the maximum width x of the bearing bushing 10. The particular configuration of the bearing bushing 10 in the diagram according to FIG. 2 is therefore characterized in that the ratio r₁/r₂ of the radii of the two bearing gaps 11, 12 to one another is not constant over the maximum extent x of the bearing bushing 10 in the axial direction. In the embodiment shown here the ratio varies continuously starting from one side of the bearing bushing 10 in the axial direction towards the other side of the bearing bushing 10 in the axial direction. The gap width of the bearing gaps 11, 12 is in this case preferably constant in the axial direction.

In the exemplary embodiments described hereinafter, various possible embodiments of bearing bushings 10 according to the invention are now described. These are explained by analogy with the schematic structure shown in FIG. 2, where only differences from the structure already described are discussed in detail.

In the diagram in FIG. 3 the bearing bushing 10 is designed very similarly to the configuration shown in FIG. 2. Compared with the diagram in FIG. 2, this merely exhibits the difference that not only the first bearing gap 11 but also the second bearing gap 12 is inclined with respect to the rotational axis 14. Since the two bearing gaps are still inclined with respect to one another, it also applies here that the ratio of the radii r₁/r₂ varies continuously over the axial extent x of the bearing bushing 10. The inclinations of the bearing gaps 11, 12 are designed in this case so that they each enclose an angle α,β with the rotational axis 14 on the same side of the bearing bushing 10. The inclinations therefore run in the same direction.

The diagram in FIG. 4 shows another structure of a bearing bushing in which both bearing gaps 11, 12 are also inclined. Unlike in the embodiment of the bearing bushing 10 selected in FIG. 3, here however the extension of the first bearing gap 11 intersects the rotational axis 14 on the other side of the bearing bushing 10 from the extensions of the second bearing gap 12. The bearing gaps are therefore inclined in opposite directions. This makes it possible to compensate for force components acting in the axial direction of the rotational axis 14 since one part of the components acts in respectively one direction and another part of the components acts in respectively the other direction. Here also it applies that the ratio r₁/r₂ is not constant over the width x of the bearing bushing 10.

Another possible embodiment of the bearing bushing 10 is now shown in the diagram of FIG. 5. This is designed so that the second bearing gap 12 again by analogy with the diagram in FIG. 2 runs similarly to the lateral surface of a circular cylinder. The first bearing gap 11 on the other hand has three different sections which follow one another in the axial direction over the width x of the bearing bushing. These sections have different radii r₁. The radius r₁ therefore varies abruptly so that a stepped bearing bushing 10 on the outer surface is formed. This can absorb axial forces in addition to radial forces since in the region of the abrupt broadening of the cross-section, forces can also be introduced in the direction of the rotational axis 14. It can thus achieve the radial mounting and the axial mounting in one component. Unlike in the embodiments shown so far, the ratio r₁/r₂ in this case does not vary continuously over the width x of the bearing bushing 10 but runs in three jumps.

A similarly configured bearing bushing 10 can again be seen in FIG. 6. This in practice connects the embodiment in the diagram of FIG. 2 with the embodiment in the diagram of FIG. 5 so that a bearing bushing 10 is formed here which achieves a continuous variation of the ratio r₁ to r₂ in a first subregion, in order to then achieve an abrupt variation of this ratio before this remains constant for the remainder of the axial extent of the bearing bushing 10. A similar combination which connects the embodiments of FIGS. 3 and 5 can be seen in the diagram of FIG. 7.

FIG. 8 again takes up the exemplary embodiment already discussed within the framework of FIG. 3. Instead of a single bearing bushing 10, two bearing bushings 2 are provided here on the shaft 3. These have inclinations in different directions. The bearing bushings 10 are here configured mirror-symmetrically about a plane perpendicular to the rotational axis 14. As a result of this symmetry, comparable force components in the axial direction are obtained in the region of the left bearing bushing 10 and in the region of the right bearing bushing 10. In the structure shown in FIG. 8, an axial bearing, which is typically always more constructively complex than the radial bearing, can therefore be completely dispensed with.

FIG. 9 shows another possible embodiment of the bearing bushing 10. The bearing bushing 10 in this embodiment has the two bearing gaps 11, 12 substantially concentrically. Both bearing gaps are configured in the manner of lateral surfaces of circular cylinders. However, the two bearing gaps extend over different-sized sections in the axial direction. This results in a jump in the ratio of the radii r₁/r₂ of the two bearing gaps to one another since in sections respectively one of the radii r₁, r₂ is zero.

The embodiment of the bearing bushing 10 shown in FIG. 10 behaves similarly. Here two bearing gaps 11, 12 have the same length in axial direction but are arranged offset in axial direction to one another with their starting points or end points. This also results in jumps in the ratio of the radii r₁, r₂ to one another so that as a result, the effect according to the invention can be achieved with a comparatively simple structure.

The structure shown in FIG. 3 is again taken up in the diagram of FIG. 11. In addition to the diagram in FIG. 3, an external force which is indicated by the arrows designated with F is additionally acting here on the bearing bushing 10. This counteracts the displacement of the bearing bushing 10 in the axial direction, in the exemplary embodiment shown in FIG. 11, in the axial direction to the right so that as a result of the change in the flow ratios and the spring forces F accompanying the displacement, a self-regulating system is obtained. Any interruption of the lubricant film is thereby securely and reliably eliminated and increasing vibrations lead to a displacement of the bearing bushing 10 against the spring forces which restore these with increasing deflection of the bearing bushing 10 with increasing force so that the system ensures a stable mounting in a self-regulating manner.

In addition to the preferred embodiment with constant gap width of the bearing gaps 11, 12, an alternative embodiment is shown in FIG. 12. This has the bearing bushing 10, the first bearing gap 11 between the bearing bushing 10 and the housing 7 in such a manner that this varies its gap dimension or gap width accordingly over the axial width x of the bearing bushing 10. In the diagram in FIG. 12 the first bearing gap 11 on the right-hand side has a first gap width indicated by b₁ whereas on the opposite axial side of the bearing bushing 10 or the bearing gap 11 it has a larger gap width designated by b₂. This also leads to an inhomogeneous pressure build-up in the bearing gap which contributes to preventing undesired vibrations.

Another concept can be identified in the diagram of FIG. 13. Here the bearing bushing 10 is designed so that, as shown highly exaggerated in the diagram of FIG. 11, the central axes of the outer circular cylindrical surface, which forms the first bearing gap 11 between the bearing bushing 10 and the housing 7, and the inner circular annular surface which forms the second bearing gap 11 between the shaft 3 or the ring 13 and the bearing bushing 10, are arranged eccentrically to one another. The central axes are therefore not aligned with the rotational axis 14 of the shaft 3 but at least one of the axes deviations from the rotational axis 14 and in the diagram of FIG. 13 is arranged parallel to this.

All the embodiments described here can be combined with one another whereby, for example, one bearing of the shaft 3 is configured in one manner and the other bearing of the shaft 3 is configured in the other manner. In addition, the ideas described here can each be combined with one another in a bearing bushing 10 so that, for example, the spring forces can likewise act on eccentrically configured bearing bushings 10 or the bearing bushings 10 with varying radii ratios r₁/r₂ can additionally be arranged eccentrically and/or with varying gap width b of one of the bearing gaps 11, 12 in the axial direction.

All the configurations contribute to reducing subharmonic excitations or self-excited vibrations. They can thus minimize or prevent acoustic perturbations and can in particular ensure that the shaft 3 is not unstable in the mountings which could lead to a corresponding swinging of the system from shaft and turbine wheel 2 as well as optionally the compressor wheel 4. In the worst case this could result in damage to the rotor from shaft 3, turbine wheel 2 and compressor wheel 4. All the variants unload the axial bearing so that this, insofar as it should/must still be present can be configured to be constructively wore simply. The configurations are simply and efficient by to implement. They can, for example, replace conventional floating bushings without the other configuration of the housing 9 and/or a possible axial bearing needing to be modified substantially.

1-15. (canceled)

16. Bearing arrangement for a shaft of a turbine wheel or of a turbine wheel and of a compressor wheel, wherein
the turbine wheel is driven by the exhaust gas of a vehicle drive unit, said bearing arrangement comprising:
a static housing, which
together with a bearing bushing arranged in a rotationally movable manner relative to the housing encloses a first bearing gap, wherein
the bearing bushing accommodates the shaft in a rotationally movable manner and encloses a second bearing gap together with the shaft, wherein
a ratio (r₁/r₂) of radii (r₁, r₂) of the first bearing gap and of the second bearing gap with respect to a rotational axis of the shaft changes at least once over the maximum axial extent of the bearing bushing characterized in that
the bearing gaps are arranged eccentrically to one another or at least one of the bearing gaps has a gap width which changes in axial direction.

17. The bearing arrangement according claim 16, characterized in that at least one of the bearing gaps is inclined with respect to the rotational axis and/or the other bearing gap.

18. The bearing arrangement according to claim 16, characterized in that both bearing gaps are configured to be inclined with respect to one another.

19. The bearing arrangement according to claim 16, characterized in that one of the bearing gaps has at least one continuous or abrupt change of radius (r₁, r₂).

20. The bearing arrangement according to claim 16, characterized in that the material thickness and/or condition of the bearing bushing changes in the course of the axial width (x).

21. The bearing arrangement according to claim 16, characterized in that the bearing bushing has a static and/or dynamic imbalance with respect to its geometric central axis.

22. The bearing arrangement according to claim 16, characterized in that at least one bearing gap is dimensioned with different gap thickness along its circumference.

23. The bearing arrangement according to claim 16, characterized in that the bearing bushing is movable against a restoring force, in particular a spring force, of a restoring element, in particular a spring element acting substantially in the direction of the rotational axis of the shaft.

24. The bearing arrangement according to claim 16, characterized in that irrespective of the bearing bushing at least one second bearing bushing according to one of the preceding claims is disposed between the shaft and the housing.

25. The bearing arrangement according to claim 17, characterized in that both bearing gaps are configured to be inclined with respect to one another.

26. The bearing arrangement according to claim 17, characterized in that one of the bearing gaps has at least one continuous or abrupt change of radius (r₁, r₂).

27. The bearing arrangement according to claim 18, characterized in that one of the bearing gaps has at least one continuous or abrupt change of radius (r₁, r₂).

28. The bearing arrangement according to claim 17, characterized in that the material thickness and/or condition of the bearing bushing changes in the course of the axial width (x).

29. The bearing arrangement according to claim 18, characterized in that the material thickness and/or condition of the bearing bushing changes in the course of the axial width (x).

30. The bearing arrangement according to claim 19, characterized in that the material thickness and/or condition of the bearing bushing changes in the course of the axial width (x).

31. The bearing arrangement according to claim 17, characterized in that the bearing bushing has a static and/or dynamic imbalance with respect to its geometric central axis.

32. The bearing arrangement according to claim 18, characterized in that the bearing bushing has a static and/or dynamic imbalance with respect to its geometric central axis.

33. The bearing arrangement according to claim 19, characterized in that the bearing bushing has a static and/or dynamic imbalance with respect to its geometric central axis.

34. The bearing arrangement according to claim 20, characterized in that the bearing bushing has a static and/or dynamic imbalance with respect to its geometric central axis.

35. The bearing arrangement according to claim 17, characterized in that at least one bearing gap is dimensioned with different gap thickness along its circumference.
